(19) United States
(12) Patent Application Publication
(10) Pub. No.: US 2006/0247914 A1
(43) Pub. Date: Nov. 2, 2006

(54) SYSTEM AND METHOD FOR AUTOMATIC ENRICHMENT OF DOCUMENTS

(75) Inventors: Liran Brener, Hod Hesharon (IL); Joel Ovil, Johannesburg (ZA); Hilla Ovil, Ramat Aviv (IL); Liran Brener, Ramat Aviv (IL)

Correspondence Address: SQUIRE, SANDERS & DEMPSEY L.L.P, 600 HANSEN WAY, PALO ALTO, CA, 94304-1043, US

(73) Assignee: WHITESMOKE, INC., Wilmington, DE (US)

(21) Appl. No.: 11/164,685

(22) Filed: Dec. 1, 2005

Related U.S. Application Data
(60) Provisional application No. 60/632,728, filed on Dec. 1, 2004.

(51) Int. Cl. G06F 17/20

(52) U.S. Cl. 704/1

(57) ABSTRACT

A system and method enable the enrichment of sentences according to a specified style. The enrichment is based on the analysis of documents having the specified style and the sentence is then revised accordingly.

### CROSS REFERENCE TO RELATED APPLICATION

This application claims benefit of and incorporates by reference U.S. Patent Application No. 60/632,728, filed Dec. 1, 2004, entitled “Method and Apparatus for Automatic Enrichment (AE).”

### TECHNICAL FIELD

This invention relates generally to the modification of documents, and more particularly, but not exclusively, provides a system and method for enriching a document based on word type and document style.

### BACKGROUND

Machine translation of documents can often be unrecognizable. One of the causes of this is that the translation does not take into account the style of the original document. For example, a legal document should be translated differently from a literary document (e.g., a poem). Further, an author of a document may wish to enrich a document so that it complies with a certain style. For example, a non-lawyer may wish to write a lawyerly-sounding letter.

Accordingly, a new system and method are needed to enable enrichment of documents.

### SUMMARY

Embodiment of the invention include a system and method that enable an automatic upgrade or enrichment of a given sentence (including but not limited to: by any of the following ways: text-to-text, speech to text; text to speech, speech to speech), without a user intervention. The input to the system is comprised of sentences and profiles. The system will create a more enhanced sentence, which might be based on the user profiles (e.g.: comprehensive, general, personal, professional, commercial, business, legal, medical, science and literature). For each different profile a different optimized sentence will be created.

Embodiments of the inventions can be used for the following applications:
1. Language enhancement and language enrichment, including without derogating from the generality, suggested hierarchy of preferred replacing and/or adding of words and/or sentences.
2. Grammar check (independently developed or already made grammar check).
3. Spell check (independently developed or already made spell check)
4. Translation (e.g.: enabling the enhancement and enrichment in the same language or from one language to another, including but not limited to, English-English or English-other languages). For example: The system enables the user to exploit its features by using one language and receiving the enhancement and enrichment in the same or different languages.
5. Preposition—suggesting preferable ones placing and correcting (“in Monday” to “on Monday”).
6. Idioms and proverbs.
7. Thesaurus (including the proposing of the relevant word in the right tense plural or single form and context).
8. Performing enrichment and enhancing of text through various profiles including but not, comprehensive, general, personal, professional, commercial, business, legal, medical, science and literature.
9. Rhymes, fables.
10. Jargon, slang.
11. Visual features (e.g. emoticons, graphics, animation, pictures and moving images).
12. Audio (e.g. movies).
13. Audio-visual (voice recognition).
14. Quotations.
15. Descriptions of (e.g. emotions).
16. Encyclopedia of all fields (e.g. science, biographies and history).
17. Scrabbles.
18. Etymology.
19. Acronyms.
20. Eponyms.
21. Derivatives.
22. Stories.
23. Pronouncing.
24. Poems, songs.
25. Names (surnames and forenames).
26. Pictures and images.
27. Genealogy.

In addition, while designing a translation system the most difficult task is to determine a specific meaning for a word out of two or more possibilities (ambiguity). Prior arts in translation contains: statistical models, context sensitive, etc. Embodiments of the invention introduce a phase of feedback that will allows any given translation engine to minimize the replacement option for each word by using the knowledge acquired from a reader.

The system can be implemented on any linguistic platform using any database i.e., it does not require any forming and/or modifying of any database and/or dictionary.

The importance of the system is in that it creates an expert system, which imitates with one click a virtual language expert (any language; e.g.: English etc.), without any intervention from the user. The optimized sentence allows a non-native speaker with a minimal knowledge of the relevant language to create the impression of a better and/or more sophisticated writer. The system also creates a time saving apparatus that will ease the process of writing and creating a text on a computer or otherwise.

Embodiments of the invention can be implemented on any linguistic platform using any database; i.e.: It does not require a proprietary database and/or dictionary. Embodiments can use any existing database or dictionary to implement the process of an automatic linguistic and verbal enrichment.

Embodiments of the invention automatically recognize relevant contents and contexts based on a chosen user profile, and then replace and enrich automatically a sentence. The process will depend on a profile selected by the user; the profile shall reflect a given style and thus will create a different and/or better and/or more sophisticated and/or optimized version of sentences.

Embodiments of the invention depend on an Automatic Learning and Self Improving Process (ALSIP) that will enable the system to learn about the optimized use and/or combination of words and/or expressions and/or phrases and/or sentences and/or texts that suit the selected profiles. A profile describes a context such as comprehensive, general, personal, professional, commercial, business, legal, medical, science and literature. e.g.: when the user will write “solid evidence” and will choose legal profile, then the system will suggest the alternative phrase “compelling evidence”. If the user chooses another profile for the same expression, then the system suggestion will be different; e.g.: in case of science profile it will suggest “solid proof”.

Embodiments of the invention enrich documents by modifying words based on entire sentences and/or the text (and not just of the words), e.g.: the sentence “I ran out of doors” and “I ran out of the doors”. Embodiments take in account all of the parts of the sentence and/or the text. For each profile a different optimized sentence can be created. When the user changes the profile the system proposal may be changed.

Embodiments of the invention analyze each word in a sentence based on the entire sentence and/or text and then will select from the replaceable words and/or expressions and/or phrases and/or sentences and/or texts and select the most appropriate ones. After the sentence is optimized, the optimized sentence will be a grammatically, spelled and context correct sentence. For example, the system is capable of adding a pronoun or changing a pronoun to ensure the sentence is grammar intact and that its meaning is kept, i.e., in the input sentence, “this is a test” if the user replaces the component “a test” using the suggested invention to the component “examination” the system will automatically replace the pronoun “a” into the pronoun “an”. The output sentence will become “this is an examination.”

The system is further capable of changing each suggested word to the relevant tense in the original sentence.

Unlike any other prior art, the user ability is irrelevant and the user will not be asked by the system to be active and to provide a personal feedback or knowledge on the suggestion, but instead there is a sophisticated method of automatic “accept, discard, modify and upgrade”. The system creates a situation upon which a minimum involvement of the user shall been required in order to activate the system and use its output.

The present invention uses statistical, mathematical and/or other techniques (e.g.: analyzing, context sensitive and probability), to achieve the process of enrichment. However, as described bellow, the present invention achieves this process in techniques that does not require a manual matching or grouping process. Accordingly, effort and resources are reduced since there is no need for a user to create and/or maintain a database.

In an embodiment of the invention, a system comprises a parser, matching engine and optimizer. The parser capable analyzes a sentence. The matching engine, which is communicatively coupled to the parser, retrieves a list of replacement words for at least one word of the sentence. The optimizer, which is communicatively coupled to the matching engine, selects a replacement word from the list for the at least one word based on scores of each replacement word and style of the sentence, the score representing frequency of occurrence of the replacement word in a training document of the style and replaces the at least one word with the selected replacement word.

In an embodiment of the invention, a method comprises: analyzing a sentence; retrieving a list of replacement words for at least one word of the sentence; selecting a replacement word from the list for the at least one word based on scores of each replacement word and style of the sentence, the score representing frequency of occurrence of the replacement word in a training document of the style; and replacing the at least one word with the selected replacement word.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network in accordance with an embodiment of the invention;

FIG. 2 is a block diagram illustrating an enrichment system of the network of FIG. 1;

FIG. 3 is a block diagram illustrating a memory of the enrichment system of FIG. 1;

FIG. 4 is a diagram illustrating a section of a database of the memory;

FIG. 5 is a diagram illustrating another section of the database;

FIG. 6 is a diagram illustrating the enrichment of a document;

FIG. 7 is a diagram illustrating a thesaurus table;

FIG. 8 is a diagram illustrating a thesaurus score;

FIG. 9 is a diagram illustrating an example of a thesaurus table;

FIG. 10 is a diagram illustrating an example of a thesaurus score table;

FIG. 11 is a flowchart illustrating a method of training the enrichment system; and

FIG. 12 is a flowchart illustrating a method of enriching a document.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

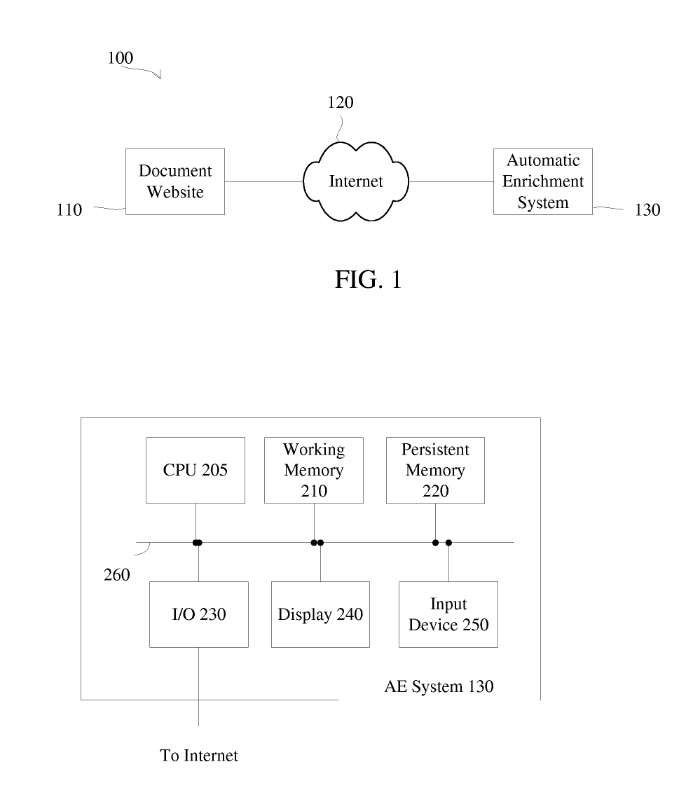

FIG. 1 is a block diagram illustrating a network 100 in accordance with an embodiment of the invention. The network 100 includes a document website 110 communicatively coupled to a network 120, such as the Internet, which is communicatively coupled to an automatic enrichment (AE) system 130. The AE system 130, as will be discussed in further detail below, engages in training and enrichment of documents. During training, the AE system 130 reviews documents, such as documents stored on the document website 110 to learn how sentences are structured according to a certain style. During enrichment, the AE system 130 analyzes and enriches a document according to a style selected by a user using knowledge acquiring during training.

FIG. 2 is a block diagram illustrating the AE system 130. The AE system 130 includes a central processing unit (CPU) 205; a working memory 210; a persistent memory 220; an input/output (I/O) interface 230; a display 240; and an input device 250; all communicatively coupled to each other via a bus 260. The CPU 205 may include an Intel Pentium microprocessor, or any other processor capable to execute software stored in the persistent memory 220. The working memory 210 may include random access memory (RAM) or any other type of read/write memory devices or combination of memory devices. The persistent memory 220 may include a hard drive, read only memory (ROM) or any other type of memory device or combination of memory devices that can retain data after the AE system 130 is shut off. The I/O interface 230 can be communicatively coupled, via wired or wireless techniques, directly, or indirectly, to the network 120. The display 240 may include a flat panel display, cathode ray tube display, or any other display device. The input device 250, which is optional like other components of the invention, may include a keyboard, mouse, or other device for inputting data, or a combination of devices for inputting data.

In an embodiment of the invention, the AE system 130 may also include additional devices, such as network connections, additional memory, additional processors, LANs, input/output lines for transferring information across a hardware channel, the Internet or an intranet, etc. One skilled in the art will also recognize that the programs and data may be received by and stored in the AE system 130 in alternative ways.

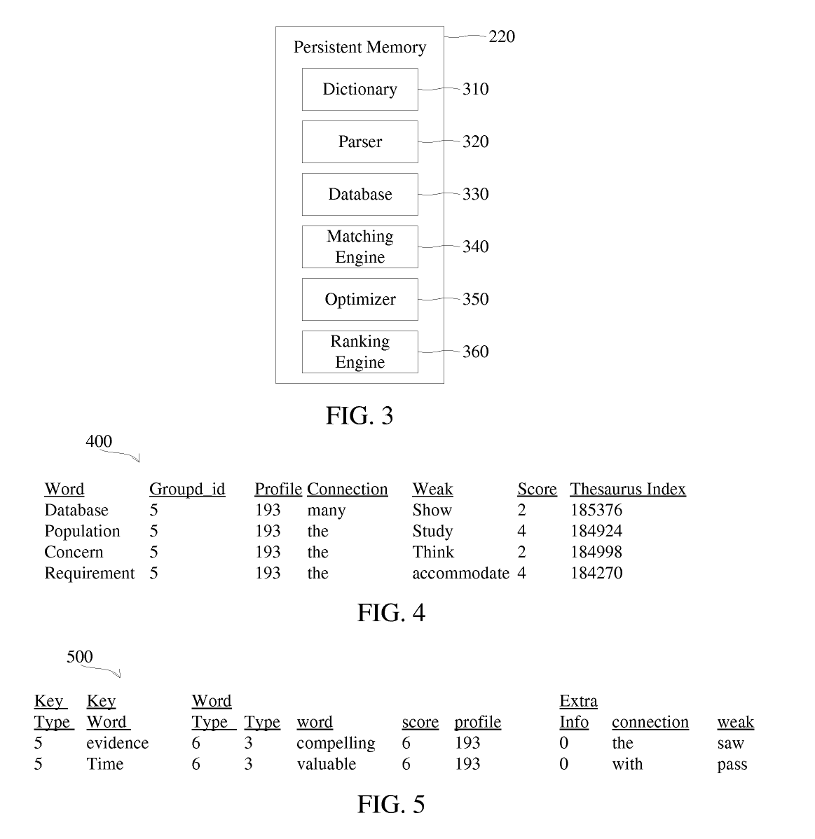

FIG. 3 is a block diagram illustrating the persistent memory 220 of the enrichment system of FIG. 1. The memory 220 includes a dictionary 310, a parser 320, a database 330, a matching engine 340, an optimizer 350, and a ranking engine 360. The dictionary 310 includes the vocabulary of the relevant language (e.g., the English language), identified using the role of the words as sentence components, i.e. “test” can be a verb and a noun. In the proposed invention any dictionary can be used. The dictionary 310 can also include replaceable words (e.g., a Thesaurus), to enable suggesting of alternative words. The replaceable words can be stored in the dictionary 310 or another file.

The parser 320 analyzes a given sentence and establishes the tagging of the words in the sentence. The parser 320 identifies sentence components. For example, for the sentence “I am going home” the parser 320 will analyze the sentence and determine for each word the role it has been used.
[I]->personal
[am]->Auxiliary very
[going]->Verb, present continues
[home]->Noun

The parser 320 can use different techniques to parse sentences, such as shift reduce parsers, context sensitive parsers, probability parsers, etc.

The database 330 stores information resulting from training process described below. The database 330 is mainly used by the matching engine 340. The matching engine 340 creates a list of alternatives to each word in the sentence based on data stored in the database 330. The optimizer 350 determines an optimal one alternative to each word and to lists the most recommended options for replacement.

In the training process the system 130 will be introduced to a series of documents (e.g., document websites, such as the document website 110 and any written materials) that reflect a certain context.

For example, to enable the system 130 to learn how to write in a legal style, the system 130 will be given a website that stores legal document and manuscripts. The system 130 will “crawl” into the website to locate all the documents relevant to law. In this way the system imitates a “reading” process.

For each document encountered, the parser 320 will analyze (“read and parse”) all the sentences and store the information in the database 330. The information is stored in the database 330 in its original tense, and includes all the information relating to the role of the word in the sentence and clues about the actual use of the word in the sentence. The following information will be stored in the database 330:
1. Each language component (noun, verb, adjective and adverb).
2. Combination of words (i.e. “compelling evidence”)
3. Its correlation with the rest of sentence components.
4. Possible “meaning”.

The ranking engine 360 scores pages from the document website 110 or other website according to a list of parameters such as:
1. number of links
2. number of html tags
3. number of sentence
4. average length of sentence

The ranking engine 360 calculates a page rank for each page the system 130 encounters. If the page rank of the page is less then a minimum rank set by a user, the ranking engine 360 will discard the page and the page will not by analyzed.

In an embodiment, the system 130 also adds the page rank to the all the information written to the database. This will enable the system to choose combination and word occurrences form text that has a better page rank, thus, a better quality.

The optimizer 350 is responsible for the process of deciding which of the words in a document should be replaced and which combination of words should be added or replaced. The optimizer 350 first analyzes a document, which includes, dividing sentences into sub-sentences and then analyzing the sentence using the parser 320 to determine the role of each word in the sentence. At the end of the process each word in the sentence is tagged with the role (noun, verb, adverb, adjective, preposition, pronoun).

Next, the optimizer 350 retrieves a list of all the options for each word (noun, verb, adjective and adverb) in the sentences from the database 330. In addition, the optimizer retrieves combinations for each noun or verb in the sentence (e.g., retrieve adjective for each noun and adverb for each verb.

The optimizer 250 then uses mathematical principles to establish to most suitable replacement based on the data stored in the database 330 and data that was retrieved. For each word that is candidate for replacement, the optimizer 350 calculates the score of the original word and determines how many words have a greater score. From the list of words to replace find the most suitable for replacement according to the score. For each word that already has combination (i.e. for nouns that already has adjectives or for verb that already has adverbs), the optimizer 350 determines if the combination retrieved from the database 330 has a highest score, replaces the combination with the higher scoring combination, if any. If the word (noun or verb) doesn't have any combination (adjective and adverb), the optimizer 350 retrieves from the database 330 a matching combination or word with the highest score.

Before the word is changed the optimizer 350 will check for tense consistency to make sure the grammatical structure is intact. Adding an adjective or adverb keeps the grammar structure intact.

FIG. 4 is a diagram illustrating a section (or table) 400 of the database 330. The word represents the word encountered during training. The group id represents the role of the word (5—noun, 6—verb, 7—adjective, 8—adverb). The profile is the profile that represents the context (e.g., style, such as literary, medical, legal, etc.). The connection: for noun the connection represents the pronoun and for verb the connection represents preposition. Weak: this field is only used if the word is a noun, and it represents the verb that was used in conjunction with the noun. Score: the number of times the word appeared in the specific role. Thesaurus Index: represents a pointer to the specific index of the line.

FIG. 5 is a diagram illustrating another section (or table) 500 of the database 330. A discussion of the headings follows. Type: 3—connection between noun and adjective and 2 represent connection between adverb and a verb. Key Type: as in Group ID role of the word (5—noun, 6—verb, 7—adjective, 8—adverb). Key Word: the word that has a combination. Word type: same as Key Type but reflects the role of the combination of the word. Word: the combination word. Score: the number of times the combination has been encountered. Profile: represents the context (e.g., style). Extra Info: if the combination is verb to adverb, extra info represent if the adverb is before the verb or after the verb (e.g., greatly admire vs. report properly). Connection: if the combination is noun to adjective connection represent the pronoun used with the combination, if the connection is adverb to verb the connection is preposition. Weak: if the combination is noun to adjective, Weak represent the verb that encountered with the combination.

Each table 400, 500 represents different views of the writing encountered by the system 130 in the training process. Comprehension is achieved through the matching of the word in the sentence with all the sentence components against all the words in the database that were recorded with all the sentence components, thus trying to achieve an exact match to the sentence already read by the system 130. Accordingly, the success of the system 130 relates to the number of documents processed.

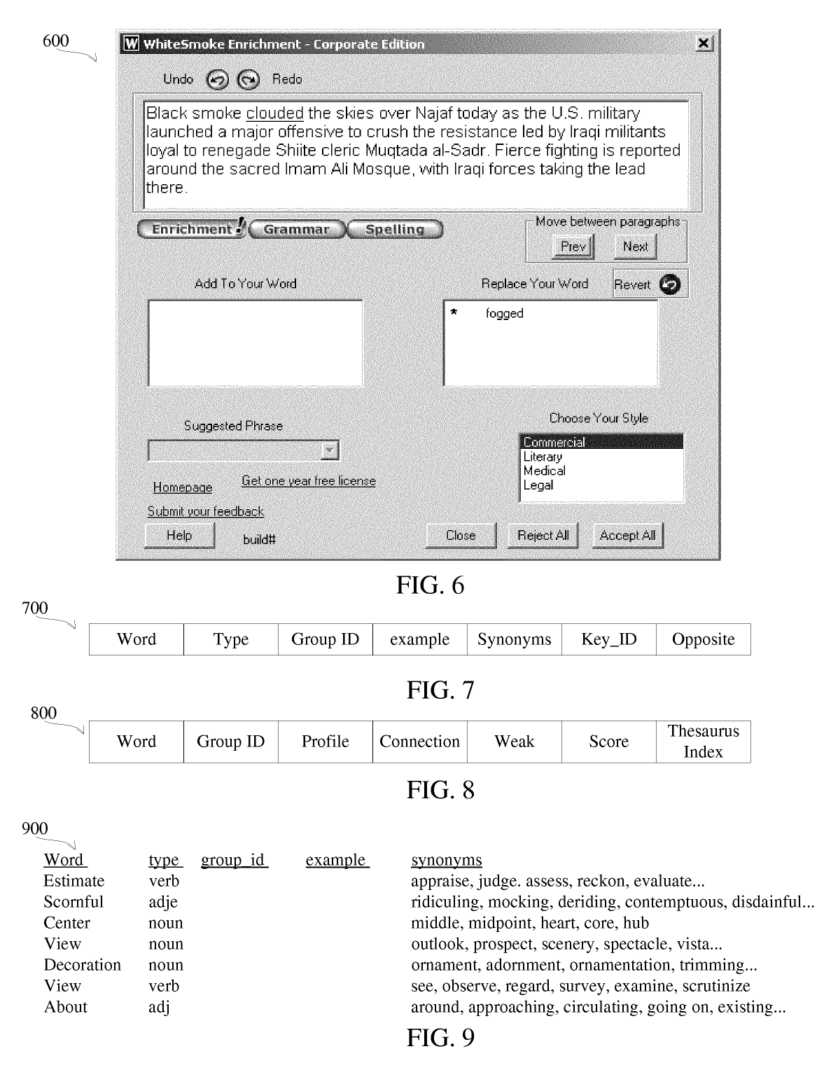

FIG. 6 is a diagram illustrating the enrichment of a document. During enrichment, a dialog display 600 can be presented to a user. The first enters his or her sentence(s) in any word processing program or service, and activates the system 130. The system 130 will open the dialog display 600, which displays the user text with an options to change a word or to add a combination of words to any specific word. Each analysis will depend on the profile selected by the user, such as legal, medical, etc.

For example, the system 130 suggests one alternative to the word “clouded” to be replaced with the word “fogged.” This suggestion is based on the knowledge base acquired by the system 130 during the training phase. The system 130 can also perform all the changes automatically and list the changes in list boxes, in that way the user can see the changes and select approve or discard for all the recommendations. In another embodiment, all changes can be done automatically without user input or approval.

In an embodiment of the invention, the system 130 can achieve different results according to special customization parameters set by a user. These parameters include the number of words that should be highlighted in the enrichment process (percentage or absolute number). Another parameter that can be changed is the type of words to be enriched. For example, enrichment can be set for rarely occurred words and word combination or common usage words and word combinations.

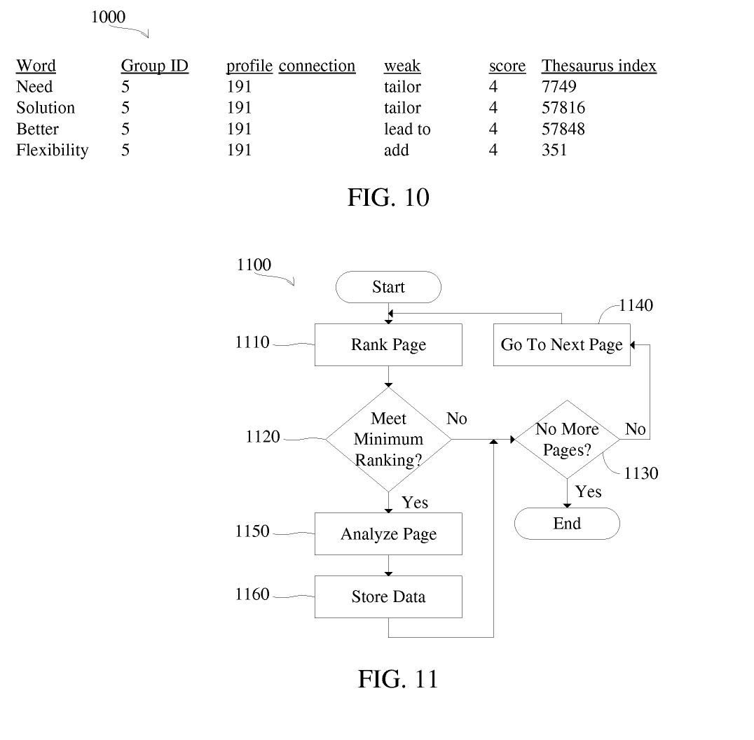

FIG. 7-FIG. 10 are diagrams illustrating is a thesaurus table 700; a thesaurus score 800; an example of a thesaurus table 900; and an example of a thesaurus score table 1000, respectively. In the training phase each time the system 130 encounters a noun, verb, adjective, adverb the system 130 will write a line into the thesaurus score table describing all the information gathered from the analysis of the specific sentence.

FIG. 11 is a flowchart illustrating a method 1100 of training the enrichment system 130. First, a page is ranked (1110) as described above. If (1120) the page does not meet a minimum ranking and there are no more paged to rank (113), then the method 1100 ends. Otherwise, the method 1100 goes to (1140) the next page and it is ranked (1100). If (1120) the page meets a minimum ranking, then the page is analyzed (1150) as described above and the data is stored (1160) in the database 330. If (1130) there are more pages to rank, then the method 1100 repeats. Otherwise, the method 1100 ends.

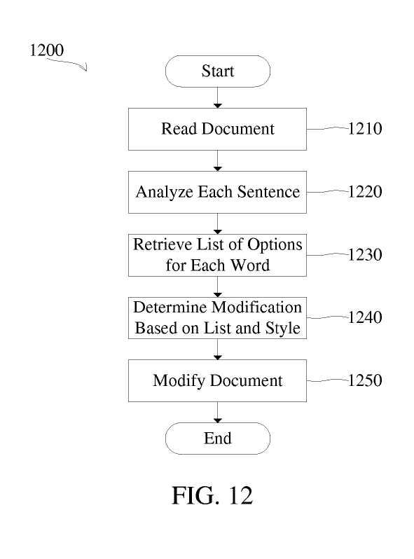

FIG. 12 is a flowchart illustrating a method 1200 of enriching a document. First, a document is read (1210). Then, each sentence is analyzed (1220). Then, a list of options for each word or word combination is retrieved (1230). Alternatively, only options for some words can be supplied according to user preferences. For each noun, verb, adjective, adverb the system will try to find the matching line in the thesaurus that best described the context of the user sentence. For each line in the thesaurus table compute a relevancy score based on an algorithm function.

In an embodiment, the arguments for the algorithm function includes arguments: a. query_word—the word we need to present synonyms for, and b. lang_type—the grammatical type of query_word. The algorithm returns a list of matching synonyms for query_word.
1. L=an empty list.
2. stem word=the stem of query word (the basic inflection), with the same grammatical type
3. For each record in the database which include stem word (the root of the word (basic tense)):
   a. Calculate the score of the record.
4. Choose the record with the maximum score.
5. For each synonym in the selected record:
   a. Find the appropriate inflection according to query word.
   b. Add the inflected word to the list L.
6. Return the list L.

Next, modifications to the documents are determined (1240) based on the list and the style (e.g., literary style will provide different options from medical style) using the highest scoring option from the returned list L. The document is then modified (1250). The modification (1250) can be fully automated without further user input or a user can be prompted for approval of each modification. The method 1200 then ends.

The foregoing description of the illustrated embodiments of the present invention is by way of example only, and other variations and modifications of the above-described embodiments and methods are possible in light of the foregoing teaching. For example, the AE system 130 can be used for simplification of documents by selecting commonly used words. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
analyzing a sentence;
retrieving a list of replacement words for at least one word of the sentence;
selecting a replacement word from the list for the at least one word based on scores of each replacement word and style of the sentence, the score representing frequency of occurrence of the replacement word in a training document of the style; and
replacing the at least one word with the selected replacement word.

2. The method of claim 1, wherein the style includes medical, literary, legal, or commercial.

3. The method of claim 1, wherein the training document used for generating a score of a replacement word when a webpage having the training document meets a minimum ranking.

4. The method of claim 3, wherein the ranking is based on a number of links to the webpage; a number of HTML tags on the webpage; a number of sentences of the training document; and average length of sentences of the training document.

5. The method of claim 1, further comprising prompting a user to authorize the replacing before the replacing.

6. The method of claim 1, wherein the analyzing includes determining a role of the at least one word and the retrieving includes retrieving replacement words with the same role.

7. The method of claim 1, further comprising:
retrieving a list of combinations for the at least one word;
selecting a combination from the list of combinations for the at least one word based on scores of each combination and style of the sentence, the score representing frequency of occurrence of the combination word in a training document of the style; and
adding the selected combination to the sentence.

8. The method of claim 7, wherein the combination includes an adverb when the at least one word includes a verb and wherein the combination includes an adjective when the at least one word includes a noun.

9. A computer-readable medium having stored thereon instructions to cause a computer to execute a method, the method comprising:
analyzing a sentence;
retrieving a list of replacement words for at least one word of the sentence;
selecting a replacement word from the list for the at least one word based on scores of each replacement word and style of the sentence, the score representing frequency of occurrence of the replacement word in a training document of the style; and
replacing the at least one word with the selected replacement word.

10. A system, comprising:
means for analyzing a sentence;
means for retrieving a list of replacement words for at least one word of the sentence;
means for selecting a replacement word from the list for the at least one word based on scores of each replacement word and style of the sentence, the score representing frequency of occurrence of the replacement word in a training document of the style; and
means for replacing the at least one word with the selected replacement word.

11. A system, comprising:
a parser capable of analyzing a sentence;
a matching engine, communicatively coupled to the parser, capable of retrieving a list of replacement words for at least one word of the sentence; and
an optimizer, communicatively coupled to the matching engine, capable of selecting a replacement word from the list for the at least one word based on scores of each replacement word and style of the sentence, the score representing frequency of occurrence of the replacement word in a training document of the style and capable of replacing the at least one word with the selected replacement word.

12. The system of claim 11, wherein the style includes medical, literary, legal, or commercial.

13. The system of claim 11, wherein the training document used for generating a score of a replacement word when a webpage having the training document meets a minimum ranking.

14. The system of claim 13, wherein the ranking is based on a number of links to the webpage; a number of HTML tags on the webpage; a number of sentences of the training document; and average length of sentences of the training document.

15. The system of claim 11, wherein the optimizer is further capable of prompting a user to authorize the replacing before the replacing.

16. The system of claim 11, wherein the parser is further capable of determining a role of the at least one word and the retrieving includes retrieving replacement words with the same role.

17. The system of claim 11, wherein the matching engine is further capable of retrieving a list of combinations for the at least one word; and
wherein the optimizer is further capable of selecting a combination from the list of combinations for the at least one word based on scores of each combination and style of the sentence, the score representing frequency of occurrence of the combination word in a training document of the style and capable of adding the selected combination to the sentence.

18. The system of claim 17, wherein the combination includes an adverb when the at least one word includes a verb and wherein the combination includes an adjective when the at least one word includes a noun.
